(19) United States
(12) Patent Application Publication
(10) Pub. No.: US 2006/0142876 A1
(43) Pub. Date: Jun. 29, 2006

(54) Location-specific adaptation of an intelligent unit

(75) Inventors: Johannes Kalhoff, Blomberg (DE); Bruno Erhardt, Blomberg (DE); Karsten Meyer-Grafe, Hovelhof (DE); Oliver Stallmann, Bunde (DE); Torsten Gast, Aerzen (DE); Dietmar Schonherr, Lemgo (DE); Michael Pistorius, Detmold (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Phoenix Contact GmbH & Co. KG, Blomberg (DE)

(21) Appl. No.: 10/539,888

(22) PCT Filed: Dec. 17, 2003
(86) PCT No.: PCT/EP03/14370

§ 371 Date: Dec. 12, 2005

(30) Foreign Application Priority Data
Dec. 19, 2002 (DE) 102 59 391.4

(51) Int. Cl. G05B 11/01

(52) U.S. Cl. 700/11; 713/1; 709/220

(57) ABSTRACT

The invention relates to the location-based adaptation of an intelligent unit. One object of the invention is to indicate a way in which, particularly in the case of network-compatible intelligent units, the intelligent units can be configured on the basis of the respective application and/or the respective installation location in order to ensure reliable, secure and thus simple association, essentially without any further steps.

For adaptation of an intelligent unit, the invention provides that a configuration device (21, 22, 24, 25) can be associated with a defined application and/or a defined location and have the capability to store application-based and/or location-based configuration data and/or behavior description data, such that data can be transmitted from the configuration device (21, 22, 24, 25) to a logic device for processing of data for configuration of the intelligent unit (11, 12, 13, 14, 15).

The invention relates to methods and apparatuses for adaptation of an intelligent unit.

Particularly in the case of network systems which comply with a standard, subscribers are conventionally nowadays addressed by means of addresses. In this case, the subscribers or network components are generally provided with the necessary addresses via address switches which, for example, are fitted to the appropriate appliances or are integrated in plugs for connection of the subscribers, or indirectly via an address which is associated with the serial number as is the case, for example, with Ethernet, and the downloading of appropriate parameters.

Particularly in the case of network systems, which relate directly or indirectly to task areas relating to security or safety, this information is, however, frequently not sufficient to produce a reliable application reference and/or location reference. For this reason, security and safety subscribers, such as specific system components or intelligent units, are nowadays conventionally equipped with additional addresses or configuration options. However, in particular once subscribers are replaced, these additions lead to further or additional handling disadvantages, such as a defined instruction for replacement, and to renewed testing of the application in situ.

No simple “plug and play” solution is currently available.

German Laid Open Specification DE-A 198 51 473 discloses coding and verification of a system component which can be connected mechanically for or by a control unit by means of a plug connector which is associated with the component and has a coding device, and a second plug connector, which is connected to an electronic circuit associated with the control unit. According to the disclosure, as the two plug connectors are mated, a signal is transmitted to the coding device that is associated with the component and, in response to the received signal, initiates a coded signal which is transmitted back to the electronic circuit, for identification evaluation.

In consequence, the coding device on whose basis a type of application-based or location-based verification of the system component is carried out by the electronic circuit that is associated with the control unit is itself associated with the component to be connected, however. No simple “plug and play” solution as described above is thus ensured and, in fact, a solution based on the trial and error principle is described, instead.

One object of the invention is thus to indicate a way in which the problems discussed above and disadvantages of the prior art are overcome and, particularly in the case of network-compatible intelligent units, this ensures configuration of the intelligent units on the basis of the respective application and/or the respective installation location, in order to guarantee reliable and thus simple association, essentially without any further steps.

According to the invention, the object is achieved by a method having the features as claimed in claim 1, by an apparatus having the features of claim 8, and/or by a system having the features of claim 27.

Advantageous and/or preferred embodiments and developments are the subject matter of the respective dependent claims.

The invention therefore provides, for adaptation of an intelligent unit, for a configuration device to be associated with a defined application and/or a defined location, in which configuration device application-based and/or location-based configuration data and/or behavior description data can be stored, so that data can be transmitted from the configuration device to a logic device for processing of data for configuration of the intelligent unit.

Since, by means of the configuration device, the invention therefore for the first time allows reliable association between the installation location of an intelligent unit such as this and the communication connection and/or configuration of the intelligent unit, particularly in fields relating to safety and security, this ensures that, for example when a unit is replaced, just the previous reading of the data which is stored in the configuration device ensures that a unit to be replaced still satisfies the expected characteristic in the corresponding application.

The invention preferably provides that the intelligent unit be provided with an associated logic device for processing of data for configuration of the intelligent unit, with this being coupled to the system based on the defined application and/or the defined location in an appropriate manner, and being connected to the configuration device in order to transmit data from the configuration device to the logic device which is associated with the intelligent unit.

Since, in consequence, the configuration device is associated with the application and/or the point of connection of the intelligent unit, and the intelligent unit is provided, based on the associated logic device, with the appropriate configuration data and/or behavior description data for configuration of the intelligent unit on an application or location basis, a connection is ensured between the installation location, the characteristic of the intelligent unit and the response of the unit.

In one particularly preferred development according to the invention, provision is in consequence also made for the application-based and/or location-based data to comprise an address, a component identification, configuration data and/or information for configuration.

Specific addressing of the respective unit is thus essentially no longer necessary, since this is done via the application-based and/or location-based configuration device according to the invention, and in consequence the system and/or the overall system addresses the intelligent units safely and reliably, and appropriately organizes the communication connection between the intelligent units for network-compatible components.

In consequence, one particularly preferred development furthermore proposes that an intelligent unit which has the associated logic device for processing of configuration data and can be connected to the configuration device, which is associated with a defined application and/or defined location, for storage of application-based and/or location-based data for transmitting data at least from the configuration device to the logic device, can preferably be included within a network. The adaptation according to the invention of application-based and/or location-based characteristics of the intelligent unit can, however, advantageously be ensured not only for network-compatible components, but also for components which are not network-compatible.

In a further preferred embodiment, the configuration device which can be associated with a defined application and/or a defined location is adapted, and can be connected to an intelligent unit which has the associated logic device, in such a way that, furthermore, data of the intelligent unit are transmitted to the configuration device and are stored there, with the configuration device thus furthermore essentially being designed to both receive and store data from the logic device which is associated with the intelligent unit, and/or with the logic device which is associated with the intelligent unit being designed for data transmission to the configuration device.

Particularly if, according to particularly preferred embodiments, the configuration device is designed for storage, reading and/or processing of further data depending on the specific application, it is possible in a very simple manner to match the data between the intelligent unit and the configuration device, with the additional capability to include, for example, delay time information.

One particularly preferred development furthermore proposes that the data of the configuration device can furthermore be exchanged, read and/or processed by remote control and/or externally, in order to ensure data access in a very simple manner, for example for carrying out an upload or download process for essentially each input/output station, in a very simple manner.

In order to allow the invention to be used in a versatile manner, one practical development of the invention furthermore provides for the steps of storage and/or transmission of the application-based and/or location-based configuration data to be carried out essentially once, in particular after the inclusion and/or replacement of an intelligent unit, and/or two or more times, in particular in order to ensure updating or adaptation of the configuration data after selectable time intervals.

The storage and/or the transmission of this data are/is in this case carried out in one expedient embodiment in a protected form, for example using a CRC method (cyclic redundancy check).

In one refinement, which is expedient from an application-specific point of view, the configuration device, in particular as equipment for an automation system and/or the intelligent unit, thus has a system component, in which case the provision of the configuration data according to the invention and/or the logic device for processing configuration data comprises application-specific and/or production-specific hardware and/or software elements.

The invention furthermore preferably provides for the configuration device to be permanently or detachably connected to the coupling location of the intelligent unit, wherein, in the simplest form, a label which is arranged at the coupling location, for example with a bar code which has data relating to the location-based and/or application-based function of the intelligent unit, is sufficient in its own right. According to another expedient proposal, the configuration device can be designed as part of permanent wiring, to which the intelligent unit can be coupled, and/or the configuration device can be associated with a connecting device, which is arranged at the coupling location of the intelligent unit, for connection of the intelligent unit.

Complementary means are in each case preferably provided for making the connection between the configuration device and the intelligent unit and/or the logic device, ensuring a unidirectional and/or a bidirectional data transmission connection. The invention in this case provides that the complementary means in this case preferably comprise optical and/or radio connectors. In one expedient embodiment, contact-based, screw-in or plug-in connectors are furthermore proposed, on an application-specific basis.

In this case, the invention advantageously proposes application-specific embodiments in which the logic device which is associated with the configuration device is part of the configuration device, or is part of a further device which can be connected to the configuration device, in particular of a central control device.

The invention furthermore covers the use of an apparatus according to the invention for carrying out the method according to the invention, as well as a system having at least one apparatus according to the invention, in particular for operation of an automation system.

The invention will be described in more detail in the following text using one preferred exemplary embodiment and with reference to the attached drawing, in which:

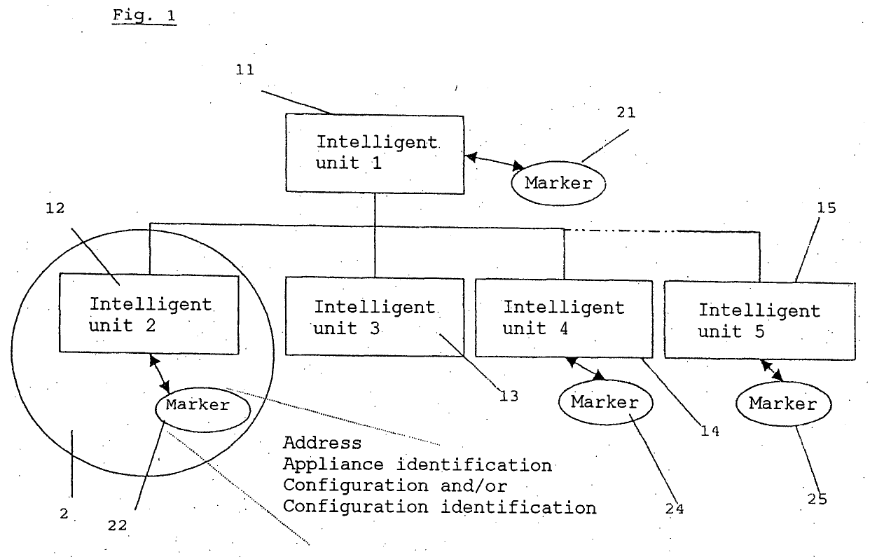

FIG. 1 shows a highly simplified outline sketch of a system for operation of an automation system comprising two or more configuration devices according to the invention, which are each connected to an intelligent unit for its location-based adaptation.

Elements of a standard network system which are essential to the invention, for operation of an automation system, will be described in a highly simplified manner with reference to FIG. 1.

In detail, FIG. 1 shows a number of intelligent units 11, 12, 13, 14 and 15, which are intended for defined applications and/or defined positions in the network. For example, the intelligent unit 2 which is annotated with the reference symbol 12 in FIG. 1 is intended for the application location annotated with the reference symbol 2.

The intelligent units 11, 12, 13, 14 and 15 thus each have system-specific system components, such as sensors and/or actuators, and also have an associated logic device, which is not illustrated in any more detail, for processing of data for configuration.

For reliable addressing of this intelligent unit 2 and, in consequence, for organization of the communication connection between the individual intelligent units 11, 12, 13, 14 and 15, the application location 2 has an associated configuration device, a so-called marker, which is annotated with the reference symbol 22 in FIG. 1, in which application-based and/or location-based configuration data is stored. In a corresponding manner, markers 21, 24 and 25 such as these are arranged in a comparable manner at the application locations of the further intelligent units 11, 14. and 15 and have data which is specific for the respective application or the respective application location.

In particular, an appliance number is allocated to the respective intelligent unit 11, 12, 14 or 15 via a respective marker 21, 22, 24 or 25 such as this, such as an address for protected communication and/or the appliance identification, which thus represents a permanent characteristic of the appliance to be connected or of the intelligent unit to be included. Alternatively or additionally, the invention provides for an application-location-specific appliance configuration process to be carried out via a marker 21, 22, 24 or 25 such as this, that is to say essentially to link variable characteristics of the intelligent units to be connected to them, such as predetermining application-location-specific data in order to describe the expected behavior, and/or the function of the intelligent unit to be connected, by means of the marker.

In the present example, the marker 21, 22, 24 or 25 thus includes a fixed or loadable configuration on an application-specific basis, which can be predetermined by means of hardware, for example via switches or a circuit, and/or by means of software, in accordance with the requirements.

The configuration device, which is annotated as a marker 21, 22, 24 or 25, is, according to the invention, preferably permanently connected to the application location, for example as part of the permanent wiring of the application location. However, depending on the application, it is also possible to provide for configuration devices according to the invention to be connected to the application location such that they can be replaced, for example via a plug or screw connection.

The connection to the intelligent unit itself, in each case identified by a double-headed arrow in FIG. 1, is in this case made in a very simple manner by screwing or plugging a marker 21, 22, 24 or 25 to or onto the respective component 11, 12, 14 or 15, with the aim being to produce an electrical connection for data transmission at least to the respective logic device, in particular on a contact-based basis.

The configuration device for this purpose expediently has a plug which is designed appropriately for coupling of the intelligent unit.

However, an alternative embodiment in particular also provides for a connection which is suitable for interchanging data to be produced via complementary optical and/or radio connectors.

In an expediently very simple embodiment, the marker is in this case arranged in the form of a label or a sticker at the application location, in which case a bar code, which has location-based and/or application-based adaptation data, can be scanned by a reader.

The configuration device according to the invention is thus always associated with the application location of one intelligent unit and contains all the necessary data, such as the address, appliance identification, data relating to the location-based and/or application-based function and/or information on configuration or configuration data and/or parts thereof, so that the intelligent unit reads the address which is required for its own configuration and/or reads configuration information from the marker, and/or preferably also transmits information and/or data to the configuration device for data matching, for example.

The configuration device and/or the intelligent unit are/is thus expediently designed such that both upload and/or download processes can be carried out between the two units.

In the event of replacement, that is to say when the intelligent unit 11, 12, 13, 14, or 15 is replaced, the respective marker 21, 22, 24 or 25 thus remains at the application location, and is connected to the appropriately new intelligent unit after replacement. The location-based communication and component characteristics are thus matched via the marker to the replaced unit, without any additional actions of an application-specific nature. There is thus no longer any need for configuration of the replaced unit via additional actions, for example via the engineering environment. Once the data matching process has been carried out, reliable operation can thus be started automatically, since a replaced component still provides the expected characteristic, in particular the desired technical features and/or the configuration of the component in the respective application, and with a connection remaining ensured between the installation location, the characteristic of the component and the response of the component.

This data is expediently in this case stored and/or transmitted in a protected form, for example using a CRC method. The invention thus ensures a location-based configuration of intelligent units, that is to say essentially intelligent system components such as sensors or actuators which include processing logic, and in consequence ensures the association with an application and/or a defined installation location which, in particular, represents a requirement to be ensured in the safety or security environment. In other words, the apparatus according to the invention or the method according to the invention allows reliable association between the installation location of an intelligent unit such as this and the communication connection, and/or the configuration of these components, which represents a major basis for reliable communication between network-compatible units.

However, it should be mentioned that ensuring the characteristic of the intelligent units is also provided for intelligent units which are not network-compatible. Furthermore, the invention also covers embodiments in which the processing logic is part of a further unit which interacts with the relevant intelligent unit, for example a central control unit.

The invention furthermore provides for the configuration device additionally to have the capability for storage of further information in an expedient manner, that is to say, for example, that delay time information can also be stored in it, and read from it.

The invention also covers embodiments in which the data which is stored in the configuration devices can be varied, can be read and/or can be processed in some other manner, and in particular can be further-processed, by remote control and/or externally, for example by means of a decentralized allocation unit with appropriate processing logic.

Furthermore, the invention can be used on an application-specific basis in such a way that the respective storage and/or reading of the application-based and/or location-based data is carried out as a single process, that is to say in particular after inclusion and/or replacement of an intelligent unit, and/or is preferably carried out as a repeatable process, in order, for example, to ensure updating or adaptation of the configuration data of the intelligent units after selectable or defined time intervals.

The “plug and play” solution that is provided according to the invention can thus be used in a practical manner in essentially all network systems, for example including the Ethernet, and allows simple linking and reliable addressing of essentially all input/output units which have intelligent processing logic.

Although the invention has been described with reference to use in automation systems, it should also be noted that further preferred fields of application of the invention relate in particular to fields of personnel transport and building control technology.

What is claimed is:

1. A method for adaptation of an intelligent unit to an application and/or an installation location of the intelligent unit, comprising the following steps:
associating a configuration device with a defined application and/or a defined location of the intelligent unit,
wherein the configuration device is permanently or detachably connected to the coupling location of the intelligent unit; and
storing application-based and/or location-based configuration data and/or behavior description data in the configuration device in such a way that data can be transmitted from the configuration device to a logic device for processing of data for configuration of the intelligent unit for adaptation of the intelligent unit.

2. The method as claimed in claim 1, furthermore comprising the following steps:
provisioning the intelligent unit with the associated logic device for processing of data for configuration of the intelligent unit;
coupling the intelligent unit to a system which comprises the defined application and/or the defined location;
connecting the intelligent unit to the configuration device; and
transmitting data from the configuration device to the logic device.

3. The method as claimed in claim 1, further comprising data from the intelligent unit being transmitted to the configuration device and being stored therein.

4. The method as claimed in claim 1, further comprising data matching being carried out between the intelligent unit and the configuration device.

5. The method as claimed in claim 1, further comprising the intelligent unit being within a network.

6. The method as claimed in claim 1, further comprising the storing and/or the transmitting of the application-based and/or location-based configuration data and/or behavior description data being carried out as a single step, or as a repeatable step.

7. The method as claimed in claim 1, further comprising the storing and/or the-transmitting of the application-based and/or type-based configuration data and/or behavior description data securely.

8. An apparatus for carrying out the method as claimed in claim 1.

9. The apparatus as claimed in claim 8, comprising:
an intelligent unit with an associated logic device for processing data for configuration of the intelligent unit; and
a configuration device which is associated with a defined application and/or a defined location, and is permanently or detachably connected to the coupling location of the intelligent unit, for storage of application-based and/or location-based configuration data and/or behavior description data,
wherein the intelligent unit and the configuration device can be connected to one another in such a way that data can be transmitted at least from the configuration device to the logic device for adaptation of the intelligent unit to the application and/or the location.

10. The apparatus as claimed in claim 8, comprising:
a configuration device, which can be associated with a defined application and/or a defined location of an intelligent unit and can be permanently or detachably connected to the coupling location of the intelligent unit, for storage of application-based and/or location-based configuration data and/or behavior description data,
wherein the configuration device can be connected to a logic device for processing of data for configuration of an intelligent unit in such a way that data can be transmitted at least from the configuration device to the logic device.

11. The apparatus as claimed in claim 8, comprising:
an intelligent unit with an associated logic device for processing of data for configuration of the intelligent unit,
wherein the intelligent unit can be connected to a configuration device, which is associated with a defined application and/or a defined location of the intelligent unit and is permanently or detachably connected to the coupling location of the intelligent unit, for storage of application-based and/or location-based configuration data and/or behavior description data, in such a way that data can be transmitted at least from the configuration device to the logic device for adaptation of the intelligent unit to the application and/or the location.

12. The apparatus as claimed in claim 8, further comprising:
the intelligent unit being within a network.

13. The apparatus as claimed in claim 8, further comprising:
the intelligent unit having a system component.

14. The apparatus as claimed in one of claim 8, further comprising:
the application-based and/or location-based data comprising an address, a component identification, configuration data and/or data for configuration.

15. The apparatus as claimed in claim 8, further comprising:
the logic device which is associated with the intelligent unit being designed for data transmission to the configuration device.

16. The apparatus as claimed in claim 8, further comprising:
the configuration device being designed to receive and store data from the logic device which is associated with the intelligent unit.

17. The apparatus as claimed in one of claims 8 to 16, furthermore comprising:
the configuration device being part of permanent wiring, to which the intelligent unit can be coupled.

18. (canceled)

19. The apparatus as claimed in claim 8, further comprising:
the configuration device being associated with a connecting device, which is arranged at the coupling location of the intelligent unit, for connection of the intelligent unit.

20. The apparatus as claimed in claim 8, further comprising:
the configuration device being designed for storage, reading and/or processing of further data.

21. The apparatus as claimed in claim 8, further comprising:
the data of the configuration device being variable, readable and/or processable by remote control and/or externally.

22. The apparatus as claimed in claim 8, further comprising:
the configuration device and the intelligent unit having complementary means for provision of a unidirectional and/or bidirectional data transmission connection, in particular using screw-in and/or plug-in connectors, a contact-based , optical and/or a radio connection.

23. The apparatus as claimed in claim 8, further comprising:
the configuration device being designed as equipment for an automation system.

24. The apparatus as claimed claim 8, further comprising:
the configuration device and/or the logic device having hardware and/or software elements.

25. The apparatus as claimed in claim 8, further comprising:
the logic device which is associated with the configuration device being part of the configuration device or part of a further device which can be connected to the configuration device, in particular a central control device.

26. Use of an apparatus as claimed in one of claims 8 for carrying out a method as claimed in claim 1.

27. A system having at least one apparatus as claimed claim 8.

28. The system as claimed in claim 26, wherein the system is adapted for operation of an automation system.
